(19) United States
(12) Patent Application Publication
(10) Pub. No.: US 2006/0236666 A1
(43) Pub. Date: Oct. 26, 2006

(54) Ventilator having effective filter device

(76) Inventor: Tsung Chuan Hung, Taipei (TW)

Correspondence Address: CHARLES E. BAXLEY, ESQ., 90 JOHN STREET, THIRD FLOOR, NEW YORK, NY, 10038, US

(21) Appl. No.: 10/940,310

(22) Filed: Sep. 14, 2004

(51) Int. Cl. B01D 46/00

(52) U.S. Cl. 55/467

(57) ABSTRACT

A ventilator includes a receptacle having a lower opening, and a partition to form a lower and an upper chambers, a casing coupled to the partition and having a passage to allowing the smoke to flow into the upper chamber of the receptacle. A filter device is disposed in the casing, to filter the smoke flowing through the space of the casing, and a drawing device is disposed above the passage of the receptacle, to draw the smoke through the filter device, and to allow the smoke to be filtered by the filter device. The filter device includes a filter screen preferably tilted relative to the casing, to collect oil or grease. A dust collector may be disposed above the filter screen, to collect smaller oil or grease particles.

### BACKGROUND OF THE INVENTION

1. Field of the Invention

The present invention relates to a ventilator or a smoke exhauster, and more particularly to a ventilator having a filter device for effectively filtering and removing smoke and vaporized oil.

2. Description of the Prior Art

The most typical ventilators or smoke exhausters comprise one or more fan devices disposed in a fan casing, for drawing smoke out of house buildings.

However, the typical ventilators or smoke exhausters do not have any filtering devices for filtering or removing smoke and/or vaporized oil, such that the smoke and/or vaporized oil may be directly blown out of the house buildings, and may thus pollute our environment.

In order to prevent our environment from being polluted by the smoke and/or vaporized oil, one or more filtering devices have been provided and engaged into the typical ventilators or smoke exhausters, in order to filter or remove the vaporized oil form the smoke.

For example, U.S. Pat. No. 5,470,365 to Jang discloses one of the typical ventilators or smoke exhausters comprising one or more filtering devices disposed in the inlet portion of the typical ventilators or smoke exhausters, for filtering or removing the vaporized oil form the smoke.

However, the smoke may only flow through the filtering devices under pressure, or the smoke may not flow through the filtering devices unless the smoke is pressurized. In Jang, the filtering devices are disposed in the inlet portion of the typical ventilators or smoke exhausters, such that the smoke may not be easily drawn through the filtering devices unless the smoke is suitably pressurized.

U.S. Pat. No. 6,214,073 to Chiang et al., and U.S. Pat. No. 6,284,011 to Chiang et al. disclose two further typical ventilators or smoke exhausters each comprising one or more filtering devices disposed in the outlet portion of the typical ventilators or smoke exhausters, for filtering or removing the vaporized oil form the smoke.

However, the filtering devices are disposed in the outlet portion of the typical ventilators or smoke exhausters, and the filtered smoke may be directly flown out of the typical ventilators or smoke exhausters right after flowing through the filtering devices, and the vaporized oil or other particles may not be effectively filtered by the typical filtering devices.

The present invention has arisen to mitigate and/or obviate the afore-described disadvantages of the conventional ventilators.

### SUMMARY OF THE INVENTION

The primary objective of the present invention is to provide a ventilator or a smoke exhauster including a filter device disposed in an intermediate portion thereof for effectively filtering and removing smoke and vaporized oil.

In accordance with one aspect of the invention, there is provided a ventilator comprising a receptacle including a lower opening formed therein for allowing gas or smoke to flow into the receptacle, the receptacle including a partition disposed therein to separate an interior of the receptacle into a lower chamber and an upper chamber, the lower chamber of the receptacle being communicating with the lower opening of the receptacle, to allow the smoke to flow into the lower chamber of the receptacle, a casing disposed in the receptacle, and coupled to the partition, and having a space formed therein and communicating with the lower chamber of the receptacle, for allowing the smoke to flow into the space of the casing, the casing including a passage formed therein for communicating the space of the casing with the upper chamber of the receptacle, and for allowing the smoke to flow into the upper chamber of the receptacle via the passage of the casing. The receptacle includes a number of outer orifices formed therein and communicating with the upper chamber of the receptacle. A filter device is disposed in the space of the casing, to filter the smoke flowing through the space of the casing, and a drawing device is disposed in the receptacle, and disposed above the passage of the receptacle, to draw the smoke through the filter device, and to allow the smoke to be filtered by the filter device.

The filter device includes a filter screen disposed in the casing, to filter the smoke. The filter screen is preferably tilted relative to the casing and the receptacle. For example, the filter screen is tilted downwardly from a front portion of the casing toward a rear portion of the casing, to collect oil or grease in the rear portion of the filter screen.

A cup may further be provided and coupled to the lower portion of the guide member, to collect the oil or grease flown toward the rear portion of the filter screen. A guide member may further be provided and coupled between the rear portion of the filter screen and the cup, to guide the oil or grease into the cup.

The filter device includes a dust collector disposed in the space of the casing, and disposed above the filter screen. The dust collector is preferably spaced away from the filter screen for a predetermined distance.

The drawing device preferably includes a guide fence engaged into the passage of the receptacle. A light device may further be provided and attached to the partition, to light the receptacle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a ventilator or a smoke exhauster in accordance with the present invention;

FIGS. 2, 3 are cross sectional views taken along lines 2-2 and 3-3 of FIG. 1 respectively,

FIG. 4 is a perspective view illustrating the other arrangement of the ventilator; and

FIG. 5 is a cross sectional view taken along lines 5-5 of FIG. 4.

### DETAILED DESCRIPTION OF THE PREFERRED EMBODIMENT

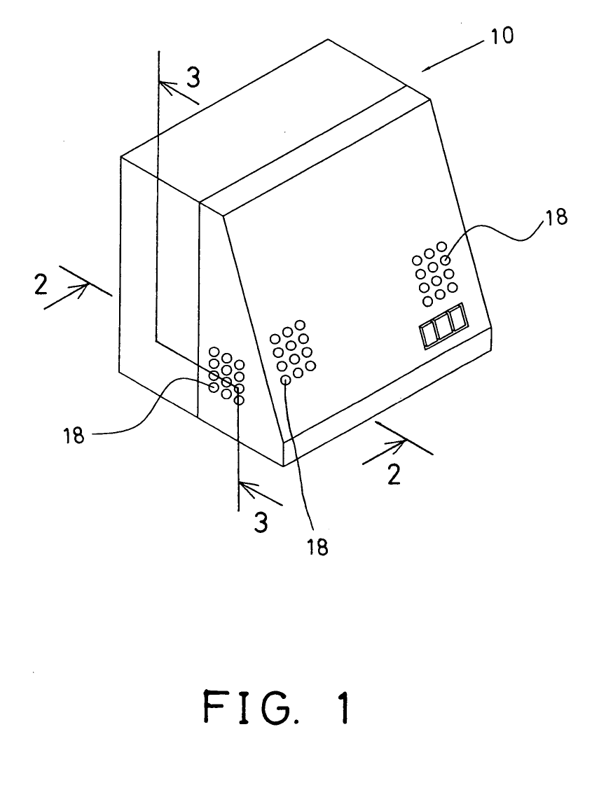

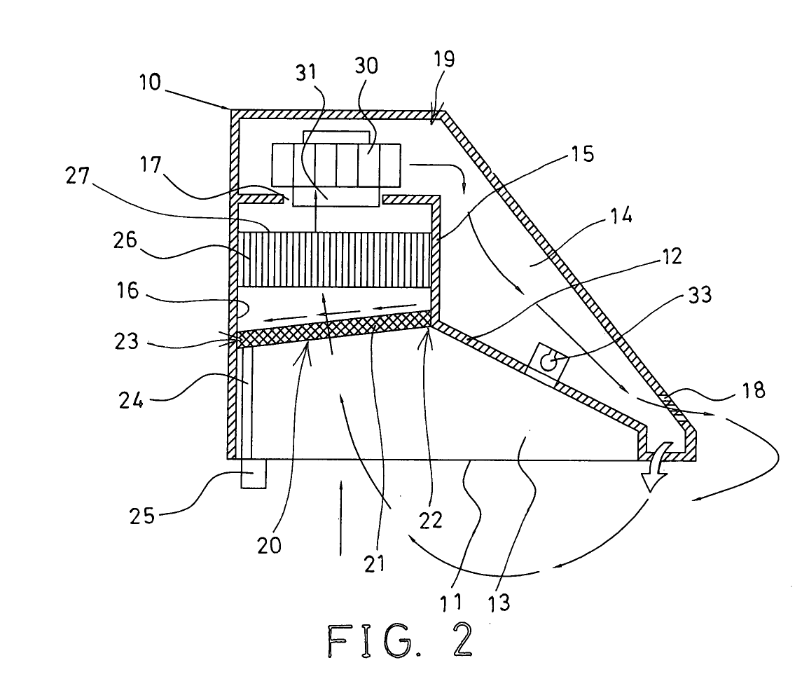

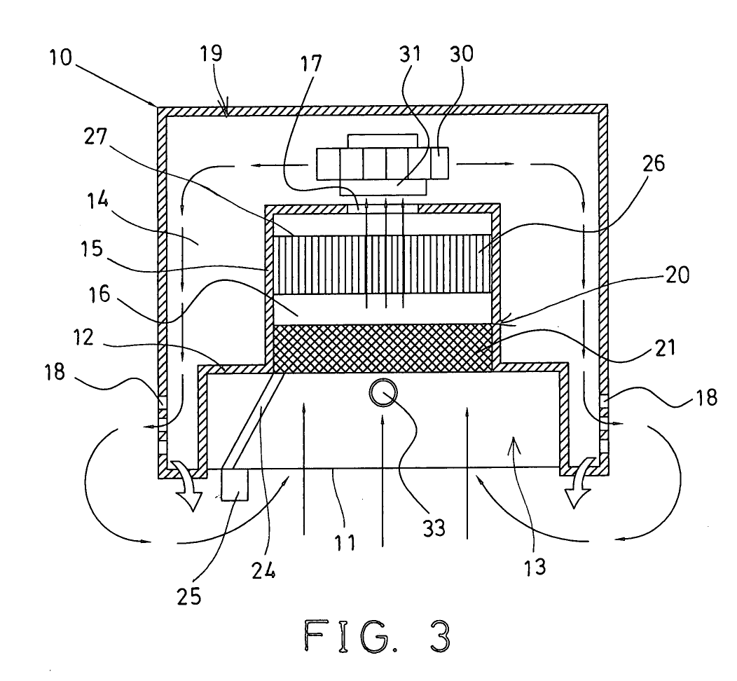

Referring to the drawings, and initially to FIGS. 1-3, a ventilator or a smoke exhauster in accordance with the present invention comprises a receptacle 10 including a lower opening 11 formed therein for allowing gas or smoke to flow into the receptacle 10, and including a partition 12 disposed in an intermediate portion and/or a front portion thereof, to separate the interior of the receptacle 10 into a lower chamber 13 and an upper chamber 14, in which the lower chamber 13 of the receptacle 10 is communicating with the lower opening 11 of the receptacle 10, to allow the gas or the smoke to easily flow into the lower chamber 13 of the receptacle 10.

The receptacle 10 includes a casing 15 disposed in the intermediate portion and/or a rear portion thereof, and coupled to or extended from the partition 12, and preferably extended or located upwardly from the partition 12, and having a space 16 formed therein and communicating with the lower chamber 13 of the receptacle 10, for allowing the gas or the smoke to flow into the space 16 of the casing 15. In addition, the casing 15 is arranged to prevent the gas or the smoke from directly flowing into the upper chamber 14 of the receptacle 10 from the lower chamber 13 of the receptacle 10.

The casing 15 includes a passage 17 formed in the upper portion thereof for communicating the space 16 of the casing 15 with the upper chamber 14 of the receptacle 10, and for allowing the gas or the smoke to flow into the upper chamber 14 of the receptacle 10 only via the passage 17 of the casing 15. The receptacle 10 further includes a number of orifices 18 formed in the outer peripheral portion thereof and communicating with the upper chamber 14 of the receptacle 10, for allowing the gas to flow out of the upper chamber 14 of the receptacle 10.

A filter device 20 is disposed in the space 16 of the casing 15, and includes a filter screen 21 disposed or secured in the lower portion of the casing 15, for filtering the gas or the smoke and/or for removing and collecting oil or grease from the gas or the smoke. It is preferable that the filter screen 21 is disposed or arranged tiltedly or inclinedly relative to the casing 15 and/or the receptacle 10, and preferably tilted downwardly from a front portion 22 toward a rear portion 23 thereof, for allowing the collected oil or grease to flow rearwardly and downwardly toward the rear portion 23 of the filter screen 21.

A guide tube or guide member 24 is coupled to the rear portion 23 of the filter screen 21, and a cup 25 is disposed or coupled to the lower portion of the guide member 24, to collect the oil or grease that has flown toward the rear portion 23 of the filter screen 21. It is preferable that the filter screen 21 and/or the filter device 20 is detachably secured to the casing 15 with fasteners, latches, locks, (not shown) or the like, for allowing the filter screen 21 and/or the filter device 20 to be easily detached or disengaged from the casing 15, for such as cleaning purposes, or for being replaced with the other new ones.

The filter device 20 further includes a dust collector 26 disposed in the space 16 of the casing 15, and preferably disposed or secured in the upper portion of the casing 15, and located above the filter screen 21, and preferably spaced away from the filter screen 21 for a suitable distance. The dust collector 26 of the filter device 20 may be changed with static electricity, which may act onto the smoke to convert the oil or grease particles into positive electricity, and may include a collecting board 27 having negative electricity, to attract and to collect the oil or grease particles of positive electricity, and thus to allow the oil or grease particles to be effectively collected.

A drawing device 30, such as a fan device 30 is disposed in the upper portion 19 of the receptacle 10, and disposed above the passage 17 of the receptacle 10, to draw the gas or the smoke through the filter screen 21 and/or the dust collector 26 of the filter device 20, to allow the smoke to be effectively filtered by the filter screen 21 and/or the dust collector 26 of the filter device 20. The drawing device 30 may include a guide fence 31 engaged into or around the passage 17 of the receptacle 10, to allow the gas or the smoke to be effectively drawn through the filter screen 21 and/or the dust collector 26 of the filter device 20 and through the passage 17 of the receptacle 10.

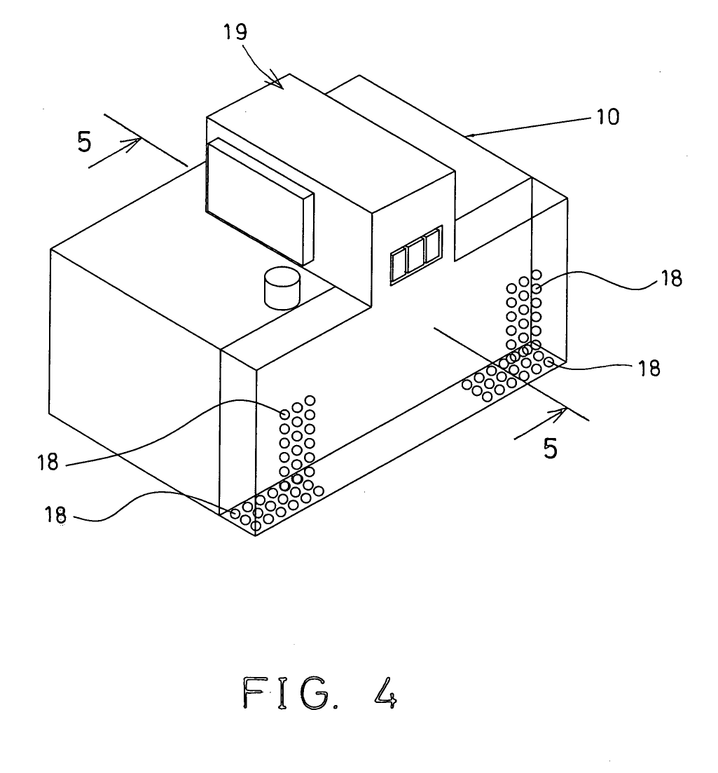

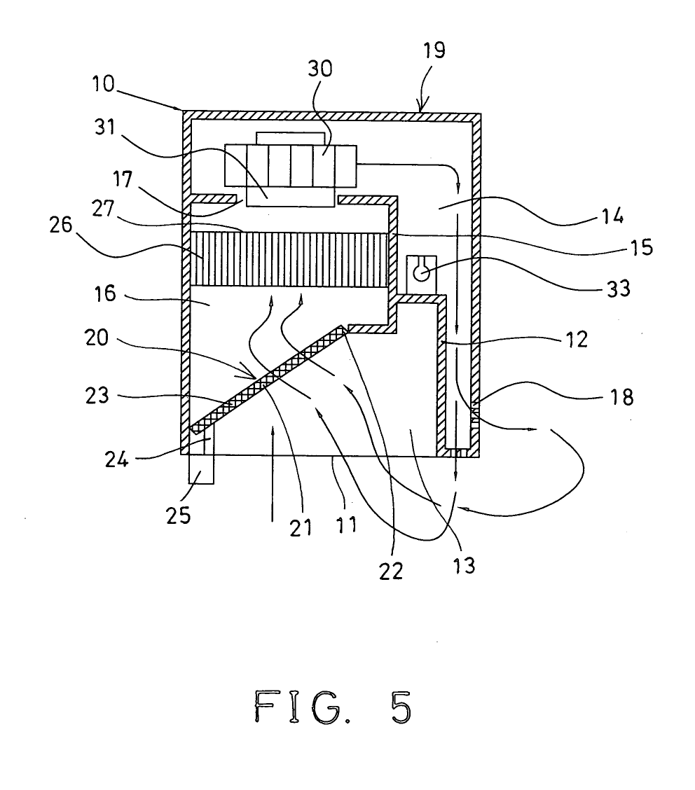

The gas or the smoke filtered by the filter screen 21 and/or the dust collector 26 of the filter device 20 may then be forced to flow into the upper chamber 14 of the receptacle 10, and then to flow out of the receptacle 10 via the orifices 18 of the receptacle 10. As shown in FIGS. 4 and 5, the receptacle 10 may be formed or arranged into various kinds of shapes or contours, to fit various kinds of spaces of the house buildings. A light device 33 may further be provided and attached to the partition 12, to light the lower portion of the receptacle 10 and the lower chamber 13 of the receptacle 10.

It is to be noted that the gas or the smoke is guided or forced by the drawing device 30, to flow from the lower chamber 13 of the receptacle 10, through the space 16 and the passage 17 of the casing 15, and through the filter device 20, and then to flow through the upper chamber 14 of the receptacle 10, and then to flow out through the orifices 18 of the receptacle 10. The arrangement of the filter device 20 in the space 16 of the casing 15, and in the middle portion of the receptacle 10, and between the lower chamber 13 and the upper chamber 14 of the receptacle 10 allows the gas or the smoke to be effectively drawn through and filtered by the filter device 20.

In addition, the greater oil or grease particles may first be filtered by the filter screen 21 the filter device 20, and then collected in the cup 25 via the guide member 24, and the smaller oil or grease particles may then be filtered or collected by the dust collector 26 of the filter device 20, such that the gas or the smoke may be effectively filtered by the filter device 20.

Accordingly, the ventilator in accordance with the present invention includes a filter device disposed in an intermediate portion thereof for effectively filtering and removing smoke and vaporized oil.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ventilator comprising:
a receptacle including a lower opening formed therein for allowing gas or smoke to flow into said receptacle, said receptacle including a partition disposed therein to separate an interior of said receptacle into a lower chamber and an upper chamber, said lower chamber of said receptacle being communicating with said lower opening of said receptacle, to allow the smoke to flow into said lower chamber of said receptacle,
a casing disposed in said receptacle, and coupled to said partition, and having a space formed therein and communicating with said lower chamber of said receptacle, for allowing the smoke to flow into said space of said casing, said casing including a passage formed therein for communicating said space of said casing with said upper chamber of said receptacle, and for allowing the smoke to flow into said upper chamber of said receptacle via said passage of said casing,
said receptacle including a plurality of outer orifices formed therein and communicating with said upper chamber of the receptacle,
a filter device disposed in said space of said casing, to filter the smoke flowing through said space of said casing, and
a drawing device disposed in said receptacle, and disposed above said passage of said receptacle, to draw the smoke through said filter device, and to allow the smoke to be filtered by said filter device.

2. The ventilator as claimed in claim 1, wherein said filter device includes a filter screen disposed in said casing, to filter the smoke.

3. The ventilator as claimed in claim 2, wherein said filter screen is tilted relative to said casing and said receptacle.

4. The ventilator as claimed in claim 2, wherein said filter screen is tilted downwardly from a front portion of said casing toward a rear portion of said casing, to collect oil or grease in said rear portion of said filter screen.

5. The ventilator as claimed in claim 4 further comprising a cup coupled to said lower portion of said guide member, to collect the oil or grease flown toward said rear portion of said filter screen.

6. The ventilator as claimed in claim 5 further comprising a guide member coupled between said rear portion of said filter screen and said cup, to guide the oil or grease into said cup.

7. The ventilator as claimed in claim 2, wherein said filter device includes a dust collector disposed in said space of said casing, and disposed above said filter screen.

8. The ventilator as claimed in claim 7, wherein said dust collector is spaced away from said filter screen for a predetermined distance.

9. The ventilator as claimed in claim 1, wherein said drawing device includes a guide fence engaged into said passage of said receptacle.

10. The ventilator as claimed in claim 1 further comprising a light device attached to said partition, to light said receptacle.
